(19) United States
(12) Patent Application Publication
(10) Pub. No.: US 2002/0172309 A1
(43) Pub. Date: Nov. 21, 2002

(54) Universal clock reference

(75) Inventor: Ting Dean Cheng, Mahopac, NY (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 09/855,456

(22) Filed: May 15, 2001

(51) Int. Cl. H04L 7/00

(52) U.S. Cl. 375/356

(57) ABSTRACT

A system and method of synchronizing a pair of communication devices using a carrier signal from a global positioning system (GPS). The method comprises the steps of: receiving a GPS carrier signal at a first device; at the first device, deriving from the carrier signal a transmitter clock signal having a predetermined frequency; transmitting data at the predetermined frequency from the first device; receiving the data at a second device; receiving the GPS carrier signal at the second device; and at the second device, deriving from the carrier signal a receiver clock signal having the predetermined frequency.

### BACKGROUND OF THE INVENTION

1. Technical Field

The present invention relates generally to high speed communication systems, and more particularly to a system and method of utilizing a carrier signal from a global positioning system (GPS) to derive reference clocks for remotely located communication devices.

2. Related Art

In order for high bandwidth communications to take place between two devices, the frequency being used for the carrier signal must be synchronized for both devices. That is, the transmitting device and the receiving device both must be operating at precisely the same frequency, or the receiver will not be able to understand the transmitted data. Traditionally, high speed communication devices, such as components in local area networks (LANS) and cellular systems, include an internal reference clock, and then use a phase lock loop (PLL) circuit to lock up the precise frequency of the data being received. PLL circuits operate by forcing an oscillator to track the frequency and phase of an input signal.

Unfortunately, for high bandwidth communications in both a wired or wireless environment, the use of a PLL creates an unavoidable overhead. Namely, implementing a PLL is costly, both in terms of hardware costs and operational costs. In terms of operational costs, a PLL typically requires at least 10 and often hundreds of “test” bits to synchronize a clock. In high bandwidth communications, where it is often difficult to keep clocks “in synch,” this overhead can become very expensive.

A further problem for communication devices that rely on internal reference clocks and PLL circuits relates to security. In particular, during the operation of a PLL, no protocol exists in wireless communications that can prevent a third device from tuning in to the frequency agreed to by the sender and receiver. Accordingly, the potential for having transmitted data intercepted and easily interpreted is a major concern in an environment that relies heavily on wireless communications.

While it is possible to perform communications without clock synchronization on both ends (i.e., asynchronous communications), such applications are generally limited to low bandwidth operations. In particular, one of the problems that arises with higher speed asynchronous communications is that it is difficult to capture start and stop bits at higher frequencies.

U.S. Pat. No. 5,666,330 issued to Zampetti on Sep. 9, 1997, entitled “Discipline Time Scale Generator For Primary Reference Clocks,” describes a network system that utilizes a GPS clock to discipline reference clocks at the various nodes in the network. Unfortunately, this reference does not remove the need to provide a local system for synchronizing clocks. This patent is hereby incorporated by reference.

Accordingly, there exists a need to provide a system for synchronizing clocks in remote devices without completely relying on an internal reference clock and PLL circuits. Additional needs exist to provide better security in high speed wireless communications, and to provide higher speed asynchronous communications.

### SUMMARY OF THE INVENTION

The present invention overcomes the above-mentioned limitations, as well as others, by using a carrier signal from a global positioning system (GPS) to generate a universal reference clock signal for communication devices (e.g., receivers and transmitters). In a first aspect, the invention comprises a communication system for facilitating remote communications, comprising a first device having: a first global positioning system (GPS) receiver for receiving a carrier signal; a signal encoder system for encoding data using a first clock signal at a predetermined clock frequency, wherein the clock signal is derived directly from the carrier signal; and a data transmitter for transmitting the encoded data.

In a second aspect, the invention provides a communication device for receiving data encoded at a predetermined frequency, comprising: a global positioning system (GPS) receiver for receiving a carrier signal; and a signal processing system for decoding the data using a clock signal at the predetermined frequency, wherein the clock signal is derived directly from the carrier signal; wherein the encoded data includes non-GPS data (i.e., data that is not related to the time and location information provided by a GPS system).

In a third aspect, the invention provides a method for synchronizing signals in a communication system, comprising the steps of: receiving a global positioning system (GPS) carrier signal; generating a clock signal derived from the carrier signal; and synchronizing a non-GPS data stream with the clock signal.

In a fourth aspect, the invention provides a method of synchronizing a pair of communication devices, comprising the steps of: receiving a global positioning system (GPS) carrier signal at a first device; at the first device, deriving from the carrier signal a transmitter clock signal having a predetermined frequency; transmitting data at the predetermined frequency from the first device; receiving the data at a second device; receiving the GPS carrier signal at the second device; and at the second device, deriving from the carrier signal a receiver clock signal having the predetermined frequency.

In a fifth aspect, the invention provides a communication device for processing data, comprising: a global positioning system (GPS) receiver for receiving a carrier signal; a signal processing system for converting the carrier signal to a clock signal at a predetermined frequency; and a universal asynchronous receiver/transmitter (UART), wherein the UART utilizes the clock signal obtained from the signal processing system to process data.

### BRIEF DESCRIPTION OF THE DRAWINGS

The preferred exemplary embodiment of the present invention will hereinafter be described in conjunction with the appended drawings, where like designations denote like elements, and:

FIG. 1 depicts a communication system in accordance with a preferred embodiment of the present invention.

FIG. 2 depicts a flow diagram of the operation of the communication system of FIG. 1.

FIG. 3 depicts a flow diagram utilizing a GPS carrier system in an asynchronous communication system.

### DETAILED DESCRIPTION OF THE INVENTION

The present invention facilitates communications by allowing remote devices to share common clock frequencies derived directly from carrier signals generated by global positioning system (GPS) satellites. It should be understood that for the purposes of this invention, the term GPS may refer to any satellite navigation system, including, for instance, both the U.S. system and Russia's GLOSNASS system.

Currently, the GPS satellites generate two globally consistent carrier frequencies for all GPS signals. The two carrier frequencies, which operate in the L-band, are referred to as L1 and L2 and operate at 1227.6 MHz and 1575.42 MHz, respectively. The carrier frequencies are derived on each satellite from two rubidium and two cesium clocks that generate a fundamental L-band frequency of 10.23 MHz. All GPS receivers are equipped to lock up with the L1 and L2 carrier signals world wide. The carrier signals from other positioning system (e.g., GLOSNASS), are likewise readily available. Accordingly, any receiver capable of receiving the GPS carrier signals, can use the carrier signals as a basis for a universally recognizable clock reference signal, thereby obviating the need for locally generated reference signals.

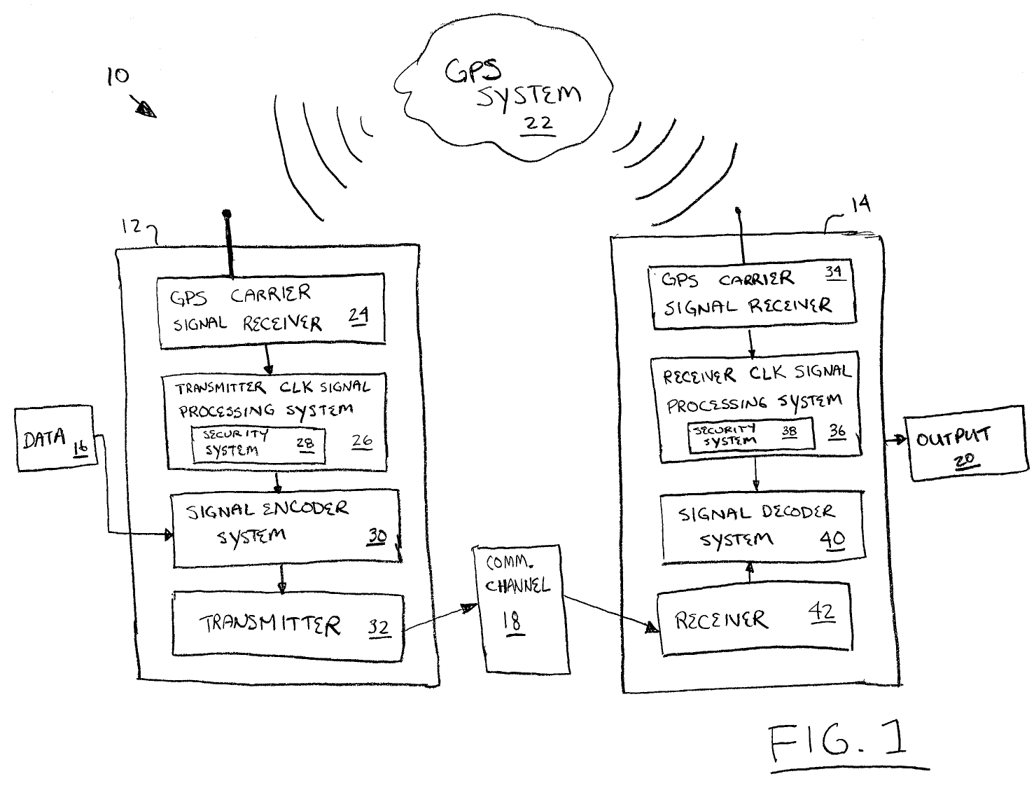

Referring now to the drawings, FIG. 1 depicts a communication system 10 for carrying out the present invention. Communication system 10 includes a first device 12 that transmits data 16 over a communication channel 18 to a second device 14. Data 16 may comprise any type of data that requires remote transmission (e.g., internet data), and therefore generally comprises non-GPS data. In this exemplary embodiment, first device 12 is described performing data transmission functions, while second device 14 is described performing data receiving functions. However, it should be understood that a device pursuant to this invention may comprise both a transmitter and receiver (i.e., a transceiver), thereby enabling the device to both send and receive data.

As described above, the invention relies on obtaining a carrier signal from a global positioning system, which is then used to generate a universal clock reference signal. Accordingly, device 12 includes a GPS carrier signal receiver 24 for receiving the carrier signal from GPS 22. As noted above, the carrier signal may include any reliable carrier signal (e.g., L1 or L2) provided by one or more satellites of GPS 22. Systems for receiving GPS signals are well known in the art. At device 12, the carrier signal is manipulated by transmitter clock signal processing system 26 to provide a suitable reference signal for device 12. In particular, transmitter clock signal processing system 26 modulates or divides the carrier signal to a transmitter clock signal having a frequency defined by a predetermined communications protocol. This process is accomplished with, for example, a formula that divides the carrier frequency using a preset denominator. Accordingly, a clock signal can be derived directly from the carrier signal, without using a local clock.

Transmitter clock signal processing system 26 may also include a security system 28 that would, for example, allow data communication to be carried out with a pre-arranged frequency hopping sequence, thereby reducing the likelihood of eavesdropping or snooping. In other words, the transmitter clock signal could change frequencies, e.g., after a predetermined time interval, after a predetermined number of bits have been processed, or randomly. Thus, transmitter clock signal processing system 26 can generate the clock signal at a plurality of predetermined frequencies. This can be accomplished, for example, by a software program that changes the preset denominator.

Once a transmitter clock signal is obtained at a predetermined frequency, the data 16 is encoded (i.e., synchronized) at that frequency by signal encoder system 30. Systems for encoding data with a clock signal are well known in the art. Once encoded, the data is transmitted via transmitter 32 (e.g., an antenna) over communication channel 18. It should be understood that signal encoder system 30 and transmitter 32 could be combined into a single functional unit. Communication channel 18 may comprise any type of wired or wireless communication link.

Similar to the first device 12, second device 14 includes a GPS carrier signal receiver 34. GPS carrier signal receiver 34 receives the same carrier signal (e.g., L1 or L2) as that of device 12 from GPS system 22. The carrier signal is then passed to a receiver clock signal processing system 36 where a receiver clock signal derived from the carrier signal is generated. In particular, the receiver clock signal is generated with a frequency that is precisely the same as the transmitter clock signal. Accordingly, receiver clock signal processing system 36 utilizes the same formula or processing means for obtaining its clock signal as does device 12.

Receiver clock signal processing system 36 also includes a security system 38 that allows device 14 to match the prearranged frequency hopping sequence used by device 12. As noted above, the hopping sequence can change frequencies, e.g., after a predetermined time interval, after a predetermined number of bits have been processed, or randomly. In the case where the frequency is changed randomly, the first device could communicate a code to the second device prior to the change, notifying the second device of the upcoming frequency change.

Device 14 receives the encoded data transmitted from device 12 via receiver 42 (e.g., an antenna). Signal decoder system 40 then utilizes the generated receiver clock signal provided by clock signal processing system 36 to synchronize and decode (i.e., extract) the data obtained by receiver 42. Once the data is decoded, the data can be stored or further processed as output 20. It should be appreciated that signal processing systems for extracting or decoding data encoded at a predetermined frequency are well known in the art. It should also be appreciated that signal decoder system 40 and receiver 42 could be incorporated into a single functional unit.

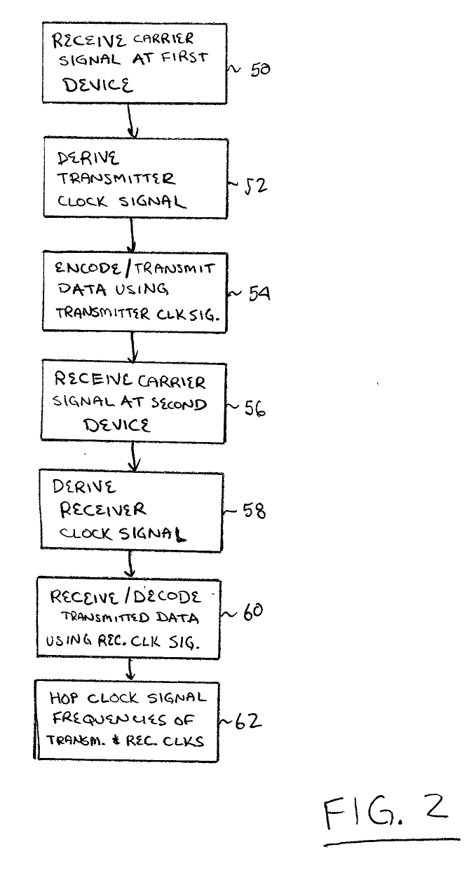

This process is described in further detail in the flow chart of FIG. 2. First, a GPS carrier signal is received by a first device 50. Subsequently, a transmitter clock signal appropriate for a predefined communication protocol is derived 52. Next, data is encoded and transmitted using the derived transmitter clock signal 54. A second device likewise receives the GPS carrier signal 56. The second device then derives a receiver clock signal 58 that operates at the same frequency as the transmitter clock signal for the first device. The transmitted data is then received and decoded using the receiver clock signal 60. Finally, the clock signal frequencies for the transmitter and receiver clocks are changed or “hopped” at a predefined sequence for security purposes 62.

The ability to provide a precise clock signal can also be exploited in an asynchronous communication system. At the heart of every asynchronous serial system is the Universal Asynchronous Receiver/Transmitter or UART. The UART is responsible for implementing the asynchronous communication process described above as both a transmitter and a receiver (both encoding and decoding data frames). The UART not only controls the transfer of data, but the speed at which communication takes place.

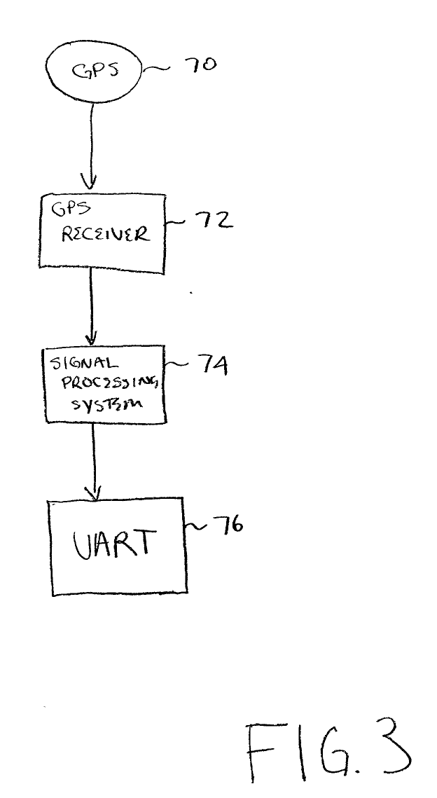

A standard asynchronous serial board with a standard 1.8432 MHz clock can only reach data transfer rates of 115.2 kbps. This is because the UART sets the baud rate by dividing down the clock frequency, and the lower the clock speed, the lower the possible data rate. One solution to faster data rates is to simply get a faster clock, which can be accomplished by the technique shown in FIG. 3—namely by dividing down an L1 or L2 carrier signal to an appropriate clock speed. As can be seen in FIG. 3, a GPS receiver 72 receives a carrier signal from GPS 70. The carrier signal is then processed (e.g., divided down) by signal processing system 74 to obtain a desirable clock signal frequency. The clock signal is then passed to UART 76, which can use the clock signal to provide faster asynchronous communications.

It is understood that the components of the present invention can be realized in hardware, software, or a combination of hardware and software. Any kind of computer system—or other apparatus adapted for carrying out the methods described herein—is suited. A typical combination of hardware and software could be a general purpose computer system with a computer program that, when loaded and executed, carries out the methods described herein. Alternatively, a specific use computer, containing specialized hardware for carrying out one or more of the functional tasks of the invention could be utilized. Aspects of the present invention can also be embedded in a computer program product, which comprises all the features enabling the implementation of the methods described herein, and which—when loaded in a computer system—is able to carry out these methods. Computer program, software program, program, module, mechanism or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A communication system for facilitating remote communications, comprising a first device having:
a first global positioning system (GPS) receiver for receiving a carrier signal;
a signal encoder system for encoding data using a first clock signal at a predetermined clock frequency, wherein the clock signal is derived directly from the carrier signal; and
a data transmitter for transmitting the encoded data.

2. The communication system of claim 1, further comprising a second device having:
a second GPS receiver for receiving the carrier signal;
a data receiver for receiving the encoded data from the transmitter; and
a signal decoder system for decoding the encoded data using a second clock signal at the predetermined clock frequency, wherein the second clock signal is derived directly from the carrier signal received from the second GPS receiver.

3. The communication system of claim 1, wherein the carrier signal is an L1 signal.

4. The communication system of claim 1, wherein the carrier signal is an L2 signal.

5. The communication system of claim 1, wherein the signal encoder system derives the first clock signal by modulating the carrier signal.

6. The communication system of claim 1, wherein the signal encoder system includes a first security system for changing the predetermined clock frequency to a predetermined sequence of frequencies.

7. The communication system of claim 6, wherein the signal decoder system includes a second security system for changing the predetermined clock frequency to the predetermined sequence of frequencies.

8. The communication system of claim 2, wherein the first and second device communicate in a synchronous manner.

9. The communication system of claim 2, wherein the first and second device communicate in an asynchronous manner.

10. A communication device for receiving data encoded at a predetermined frequency, comprising:
a global positioning system (GPS) receiver for receiving a carrier signal; and
a signal processing system for decoding the data using a clock signal at the predetermined frequency, wherein the clock signal is derived directly from the carrier signal;
wherein the encoded data includes non-GPS data.

11. The communication device of claim 10, wherein the carrier signal is selected from the group consisting of an L1 signal and an L2 signal.

12. The communication device of claim 10, wherein the encoded data comprises wireless data.

13. The communication device of claim 10, further comprising a transmitter that includes a system for encoding data using an encoder clock signal derived from the carrier signal.

14. A method for synchronizing signals in a communication system, comprising the steps of:
receiving a global positioning system (GPS) carrier signal;
generating a clock signal derived from the carrier signal; and
synchronizing a non-GPS data stream with the clock signal.

15. The method of claim 14, wherein the clock signal is generated at a predetermined frequency.

16. The method of claim 14, comprising the further step of transmitting the non-GPS data stream at the frequency of the clock signal.

17. The method of claim 14, wherein the non-GPS data stream was received from a remote transmitter also operating at the frequency of the clock signal.

18. The method of claim 14, comprising the further step of periodically changing the frequency of the clock signal.

19. A method of synchronizing a pair of communication devices, comprising the steps of:
receiving a global positioning system (GPS) carrier signal at a first device;
at the first device, deriving from the carrier signal a transmitter clock signal having a predetermined frequency;
transmitting data at the predetermined frequency from the first device;
receiving the data at a second device;
receiving the GPS carrier signal at the second device; and
at the second device, deriving from the carrier signal a receiver clock signal having the predetermined frequency.

20. The method of claim 19, comprising the further step of:
synchronizing the received data using the receiver clock signal.

21. The method of claim 19, wherein the transmitter clock signal and the receiver clock signal are derived from the carrier signal using a common formula.

22. The method of claim 19, comprising the further step of systematically altering the frequency of the transmitter clock signal and the receiver clock signal using a predefined scheme.

23. The method of claim 19, wherein the data is transmitted via a wireless communication channel.

24. A communication device for processing data, comprising:
a global positioning system (GPS) receiver for receiving a carrier signal;
a signal processing system for converting the carrier signal to a clock signal at a predetermined frequency; and
a universal asynchronous receiver/transmitter (UART), wherein the UART utilizes the clock signal obtained from the signal processing system to process data.
